(19) United States
(12) Patent Application Publication
(10) Pub. No.: US 2025/0312863 A1
(43) Pub. Date: Oct. 9, 2025

(54) FLAWLESS ALUMINUM RESISTANCE WELDING SYSTEM AND METHOD

(71) Applicants: HYUNDAI MOTOR COMPANY, Seoul (KR); KIA CORPORATION, Seoul (KR)

(72) Inventor: Seung Ho Lee, Hwaseong-si (KR)

(73) Assignees: HYUNDAI MOTOR COMPANY, Seoul (KR); KIA CORPORATION, Seoul (KR)

(21) Appl. No.: 18/945,167

(22) Filed: Nov. 12, 2024

(30) Foreign Application Priority Data
Apr. 5, 2024 (KR) 10-2024-0046939

(51) Int. Cl. B23K 11/18; B23K 11/11; B23K 11/25; B23K 103/10

(52) U.S. Cl. CPC B23K 11/185; B23K 11/115; B23K 11/253; B23K 11/255; B23K 2103/10

(57) ABSTRACT

A flawless aluminum resistance welding system includes a welding gun that includes a gun body to engage a first welding tip and a second welding tip with an upper panel and a lower panel of an object to be welded. The welding gun further includes: a pressing actuator to press the upper panel of the object at a high pressure by the first welding tip during spot welding, a welding transformer to supply a welding current for the spot welding, an air balance cylinder to adjust an air pressure to make the second welding tip in a no-load balance state, and a linear guide unit to guide the second welding tip in up and down directions. The welding gun has an equalizing function and a bidirectional pressing structure in which the second welding tip rises with a reaction force when the first welding tip presses the upper panel.

### CROSS-REFERENCE TO RELATED APPLICATION

This application claims priority to and the benefit of Korean Patent Application No. 10-2024-0046939, filed in the Korean Intellectual Property Office on Apr. 5, 2024, the entire contents of which are incorporated herein by reference.

### BACKGROUND

### (a) Field

The present disclosure relates to a flawless aluminum resistance welding system and method for improving welding quality during resistance welding of an aluminum material.

### (b) Description of the Related Art

In general, finished vehicles go through main production processes of press-welding-painting-assembly to produce end products. Among the main production processes, the most important process of determining a body in white (BIW) degree and quality of vehicle is a vehicle body parts welding process using resistance welding technology.

Recently, the automobile market is rapidly changing from internal combustion engine (ICE) vehicles to electric vehicles (EVs). EVs need to reduce the weight of a vehicle body so as to increase driving range and fuel efficiency. Accordingly, although parts of aluminum materials are widely used to reduce the weight of the vehicle body, it is difficult to secure resistance welding quality of aluminum materials compared to the existing steel materials.

For example, FIG. 11 illustrates factors of change in welding quality during spot welding of the lower fixed type welding gun of the related art.

Referring to FIG. 11(A), spot welding of the related art is performed by engaging upper and lower welding tips provided in a welding gun 30 of a welding robot 20 with an object 10 to be welded and pressing the upper and lower welding tips while flowing high-pressure current. Also, welding work on a plurality of welding points set on the object 10 to be welded is performed continuously and repeatedly. However, the welding gun 30 of the related art has a lower fixed type, which is a unidirectional pressing structure, that causes changes in the welding quality due to welding gun sagging and pushing because of a high pressing force (e.g., 500 kgf or more) during aluminum resistance welding. During aluminum spot welding, a setting position of the object 10 to be welded may change due to various causes. The welding gun 30 of the related art has a fixed lower welding tip, which cases a problem where, if the setting position of the object (i.e., workpiece) 10 to be welded deviates from a normal value C (i.e., a normal position), it leads to an appearance quality defect due to deformation of the welding part.

In this regard, to ensure aluminum welding quality in the related art, resistance welding is performed by using a special pattern tip (i.e., aluminum spot-only pattern welding tip) with a plurality of protrusions or circular ridges formed at a tip end. However, when using the special pattern tip, there is a disadvantage of requiring specialized automatic tip dressing (ATD) facility and a problem of increasing cost to generate the pattern.

In addition, referring to FIG. 11(B), the welding part expands in a process of forming a welding nugget during aluminum resistance welding. Because an aluminum material has a high coefficient of thermal expansion unlike a steel material, pores (holes) are formed in a cooling process after forming the welding nugget, which causes a welding quality defect.

In this regard, to suppress the occurrence of pores in the nugget during aluminum resistance welding, a multi-stage pressing control method (system) that adjusts a pressing force in multiple stages is applied. However, to implement the multi-stage pressing control system, expensive pressing force feedback force sensors and magnetic drive facility are required, which causes a problem of increasing equipment investment costs. In addition, there is a problem in that it is difficult to set control timing during the multi-stage pressing control, making it difficult to maintain the facility.

The matters described in the Background section are only provided to enhance the understanding of the background of the present disclosure, and may include matters that are not already known to those of ordinary skill in the art to which this technology pertains.

### SUMMARY

The present disclosure provides a flawless aluminum resistance welding system and method capable of providing good aluminum resistance welding quality through a general welding tip and a pressing actuator without an expensive special pattern tip and pressing force multi-stage control system facility by using an equalizing function of a welding gun and an implementation function of an aluminum material thermal expansion minimization motion.

According to an aspect of the present disclosure, an aluminum resistance welding system includes a welding gun. The welding gun includes: a gun body configured to engage a first welding tip and a second welding tip with an upper panel and a lower panel of an object to be welded, and a pressing actuator configured to press the upper panel of the object to be welded at a high pressure by using the first welding tip during spot welding, and a welding transformer configured to supply a welding current necessary for the spot welding. The welding gun further includes: an air balance cylinder configured to adjust an air pressure to bring the second welding tip, which forms a welding gun lower part, into a no-load balance state, and a linear guide unit configured to guide a movement of the second welding tip in up and down directions. In particular, the welding gun has an equalizing function and a bidirectional pressing structure in which the second welding tip in the no-load balance state rises with a reaction force when the first welding tip falls and presses the upper panel so that the lower panel is pressed through the pressing actuator.

In addition, the welding gun may have a structure in which the first welding tip is connected to the pressing actuator in a stroke possible linear structure (i.e., a linear structure enabling a stroke movement of the first welding tip). The second welding tip is connected to an air balance cylinder that performs an equalizing function through the gun body and the linear guide unit.

In addition, the pressing actuator may measure a depth of a welding mark of the object to be welded through an encoder during welding.

In addition, the air balance cylinder may include a cylinder position detecting sensor configured to detect cylinder position change information according to a movement of the second welding tip; and a pressure detecting sensor configured to measure pressures of a first port and a second port embedded in the air balance cylinder and transmit the measured pressures to a monitoring unit.

In addition, the aluminum resistance welding system may further include: a welding robot on which the welding gun is mounted and configured to move the welding gun to a designated welding point position; an air compressor configured to compress air and supply the compressed air to the welding gun; a monitoring unit configured to detect monitoring information of at least one of cylinder position change information or cylinder inside pressures of the air balance cylinder during welding; and a controller configured to control the equalizing function of the welding gun and an aluminum material thermal expansion minimization motion by adjusting the air pressure of the air balance cylinder based on the monitoring information.

In addition, the controller may include a welding control module configured to control a welding current and a welding time necessary for spot welding at each preset welding point; and a pneumatic control module configured to maintain the no-load balance state by controlling the air pressure supplied to the air balance cylinder.

In addition, the controller may derive and store a balance no-load pressure for controlling the equalizing function of the air balance cylinder for each welding point and an aluminum thermal expansion minimization pressure for controlling the aluminum material thermal expansion minimization motion as setting values.

In addition, the controller may calculate the balance no-load pressure necessary for generating a rising force corresponding to a gravity force applied to a welding gun lower part in consideration of a welding gun direction for each welding point.

In addition, the controller may calculate a cylinder rising minimum pressure and a cylinder falling minimum pressure based on the gravity force, and calculate the balance no-load pressure as an average of sum of the cylinder rising minimum pressure and the cylinder falling minimum pressure.

In addition, the controller may maintain an inside of the air balance cylinder at an aluminum thermal expansion minimization pressure value upon applying a current for welding in a bidirectional pressing state of the welding gun when controlling the aluminum material thermal expansion minimization motion.

According to an aspect of the present disclosure, an aluminum resistance welding method includes: moving a welding gun that spot welds an object made of an aluminum material to a specific welding point through an equalizing function using an air balance cylinder and a bidirectional pressing structure of upper and lower welding tips of the welding gun; making the welding gun in a no-load balance state by inputting a balance no-load pressure set at the specific welding point into the air balance cylinder; setting a cylinder inside of the air balance cylinder to an aluminum thermal expansion minimization pressure of the specific welding point; starting welding by pressing and applying a current to upper and lower parts of the object to be welded through the equalizing function and the bidirectional pressing structure of the welding gun; and performing feedback control to maintain the aluminum thermal expansion minimization pressure of the cylinder inside until welding is completed.

In addition, the moving of the welding gun to the specific welding point may include loading the balance no-load pressure and the aluminum thermal expansion minimization pressure which are preset at the specific welding point.

In addition, the performing of the feedback control may include implementing a welding expansion minimization motion that occurs during aluminum resistance welding by adding/subtracting a pressure of the cylinder inside according to a current change of a cylinder position detecting sensor.

In addition, the aluminum resistance welding method may further include calculating the balance no-load pressure considering a welding gun direction for each welding point through a balance no-load pressure setting algorithm; and deriving the aluminum thermal expansion minimization pressure for each welding point through an aluminum thermal expansion minimization pressure setting algorithm.

In addition, the balance no-load pressure setting algorithm may include controlling the air balance cylinder with a minimum air pressure corresponding to a welding gun gravity force and monitoring an occurrence of an increase in a current value and a decrease in the current value of a cylinder position detecting sensor; when the increase in the current value occurs, setting a cylinder rising minimum pressure with a force 1 level greater than the gravity force according to a welding gun direction; when the decrease in the current value occurs, setting a cylinder falling minimum pressure with a force 1 level smaller than the gravity force according to the welding gun direction; and deriving the balance no-load pressure as an average of sum of the cylinder rising minimum pressure and the cylinder falling minimum pressure.

In addition, the aluminum thermal expansion minimization pressure setting algorithm may include controlling the welding gun moved to the specific welding point to the no-load balance state; starting welding by pressing and applying a current to the upper and lower parts of the object to be welded through the equalizing function and the bidirectional pressing structure of the welding gun; when a current change of a cylinder position detection sensor occurs due to a thermal expansion force upon applying the current, gradually increasing a pressure of the air balance cylinder for generating a thermal expansion reaction force corresponding to the thermal expansion force; and setting the pressure of the air balance cylinder when the current change is not detected to the aluminum thermal expansion minimization pressure of the specific welding point.

According to an embodiment of the present disclosure, through the equalizing function of the spot welding gun and the implementation of the welding expansion minimization motion that occurs during aluminum resistance welding, there is the effect of preventing sagging and pushing of the welding gun lower part even with a high pressing force of 800 kgf or more.

In addition, even if the setting position of the object to be welded changes, there is an effect of preventing deformation of the welding part by mechanically autonomously correcting the welding position through the equalizing function and the bidirectional pressing structure of the spot welding gun.

In addition, by maintaining the constant pressing force at the upper and lower parts of the spot welding gun through the bidirectional pressing structure, there is an effect of preventing pore defects due to thermal expansion of the aluminum material that occurs during spot welding. Therefore, it is possible to secure good aluminum resistance welding quality through a general welding tip and a pressing actuator without the expensive special pattern tip and the pressing force multi-stage control system facility of the related art, and thus, the effect of reducing facility investment costs may be expected.

### BRIEF DESCRIPTION OF THE DRAWINGS

FIG. 1 is a view schematically illustrating a configuration of a flawless aluminum resistance welding system according to an embodiment of the present disclosure.

FIG. 2 is a view schematically illustrating a configuration of a welding gun for ensuring aluminum welding quality according to an embodiment of the present disclosure.

FIG. 3 is a view illustrating a configuration of an air balance cylinder according to an embodiment of the present disclosure.

FIGS. 4A-4C illustrate an example of applying an equalizing function and a bidirectional pressing structure of a welding gun according to an embodiment of the present disclosure.

FIGS. 5A-5C illustrate a bidirectional pressing method through an equalizing function according to an embodiment of the present disclosure.

FIG. 6 is a flowchart illustrating a welding gun balance no-load pressure setting algorithm according to an embodiment of the present disclosure.

FIG. 7 illustrates an example of setting a welding gun balance no-load pressure for each direction according to an embodiment of the present disclosure.

FIGS. 8A-8B are conceptual views for explaining an aluminum material thermal expansion minimization motion according to an embodiment of the present disclosure.

FIG. 9 illustrates an aluminum thermal expansion minimization pressure setting algorithm for implementing an aluminum material thermal expansion minimization motion according to an embodiment of the present disclosure.

FIG. 10 is a flowchart schematically illustrating a flawless aluminum resistance welding method according to an embodiment of the present disclosure.

FIG. 11 illustrates factors of change in welding quality during spot welding of the lower fixed type welding gun of the related art.

The drawings described herein are for illustration purposes only and are not intended to limit the scope of the present disclosure in any way.

### DETAILED DESCRIPTION

With reference to the attached drawings, embodiments of the disclosure are described in detail below so that ordinary skilled in the art may easily implement the present disclosure.

The terms used herein are for the purpose of describing specific embodiments only and are not intended to limit the present disclosure. As used herein, singular forms are intended to also include plural forms unless the context clearly indicates otherwise. It should also be understood that the terms “comprises” and/or “comprising” when used herein, specify the presence of mentioned features, integers, steps, actions, elements and/or components, but do not exclude the presence or addition of one or more of other features, integers, steps, actions, elements, components, and/or groups thereof. As used herein, the term “and/or” includes any one or all combinations of the associated listed items.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Throughout the specification, the terms “first,” “second,” “A,” “B,” “(a),” “(b),” and the like may be used to differentiate various components from each other, but the components should not be limited by the terms. These terms are only used to distinguish the component from other components, and the nature, sequence, or order of the component is not limited by the terms.

It should be understood through the specification that when a component is referred to as being “connected to” or “coupled to” another component, it may be connected or coupled to the other component or intervening components may be present. In contrast, when a component is referred to as being “directly connected to” or “directly coupled to” another component, there are no intervening components present.

Throughout the specification, the terms used are for the purpose of describing a specific embodiment only and is not intended to limit the present disclosure. The singular expression includes the plural expression unless the context clearly dictates otherwise.

Additionally, it is understood that one or more of the methods below or aspects thereof may be executed by at least one or more controllers. The term “controller” may refer to a hardware device including a memory and a processor. The memory is configured to store program instructions, and the processor is specifically programmed to execute the program instructions to perform one or more processes described in more detail below. A controller may control operations of units, modules, parts, devices, or similar thereto, as described herein. It is also understood that the methods below may be performed by a device including a controller along with one or more other components, as appreciated by those having ordinary skill in the art.

Now, a flawless aluminum resistance welding system and method according to an embodiment of the present disclosure are described in detail with reference to the drawings.

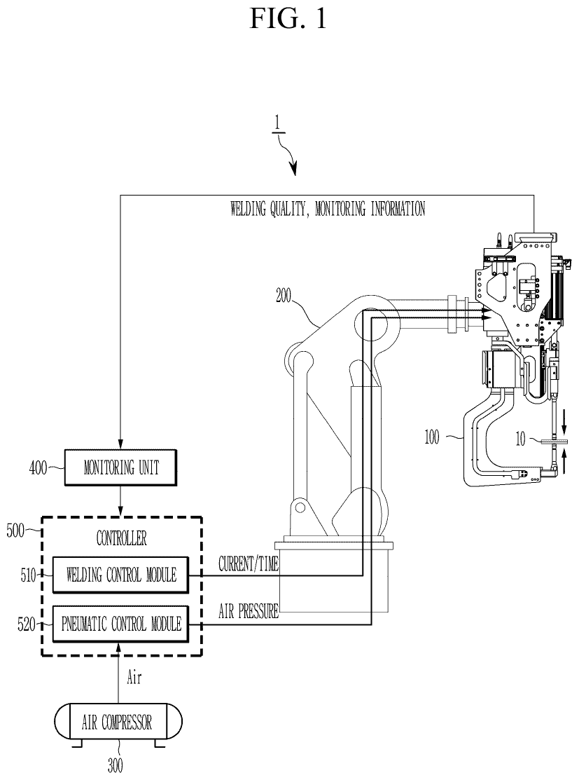

FIG. 1 is a view schematically illustrating a configuration of a flawless aluminum resistance welding system according to an embodiment of the present disclosure.

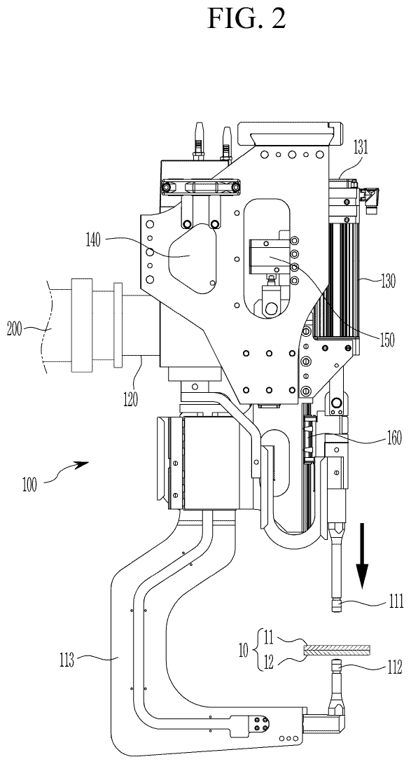

FIG. 2 is a view schematically illustrating a configuration of a welding gun for ensuring aluminum welding quality according to an embodiment of the present disclosure.

Referring to FIGS. 1 and 2, a flawless aluminum resistance welding system 1 according to an embodiment of the present disclosure is installed to automatically perform spot welding to join an object 10 (e.g., a body panel) to be welded, which is continuously supplied from a production line of a vehicle factory. Hereinafter, in the present disclosure, the spot welding is used in the same meaning as aluminum material resistance welding. Therefore, the object 10 to be welded includes an upper panel 11 and a lower panel 12, and at least one of the upper panel 11 or the lower panel 12 is made of aluminum. The upper panel 11 and the lower panel 12 may be set at a welding position through a jig and/or transfer means.

The flawless aluminum resistance welding system 1 includes a welding gun 100, a welding robot 200, an air compressor 300, a monitoring unit 400, and a controller 500.

The welding gun 100 spot welds the object 10 made of the aluminum material through an equalizing function using an air balance cylinder 150 that maintains a welding gun lower part in a no-load balance state and a bidirectional pressing structure of upper and lower welding tips 111 and 112.

The welding robot 200 mounts the welding gun 100 at a front end of an arm of a multi-joint structure and moves the welding gun 100 to a designated position of a welding point.

The air compressor 300 compresses air and supplies the compressed air to the welding gun 100.

The monitoring unit 400 monitors cylinder state information of the air balance cylinder 150 during spot welding and feeds back the cylinder state information to the controller 500. The cylinder state information may include at least one of cylinder position information or cylinder pressure information detected through a cylinder position detecting sensor 151.

In addition, the monitoring unit 400 may monitor welding quality according to a depth of a welding mark of the object 10 during spot welding and feeds back the monitored welding quality to the controller 500.

The controller 500 controls overall operations of the flawless aluminum resistance welding system 1 for securing the aluminum welding quality according to an embodiment of the present disclosure. For example, the controller 500 may control kinematic postures (motions) of the welding gun 100 and the welding robot 200 for aluminum spot welding.

The controller 500 controls the equalizing function of the welding gun 100 and an aluminum material thermal expansion minimization motion by adjusting the air pressure of the air balance cylinder 150 based on the monitoring information received from the monitoring unit 400. Though this, there is the effect of securing good aluminum resistance welding quality through a general welding tip and a general pressing actuator without the expensive special pattern tip and the pressing force multi-stage control system facility of the related art.

The controller 500 according to an embodiment of the present disclosure may include a welding control module 510 and a pneumatic control module 520.

The welding control module 510 controls a welding current and a welding time necessary for spot welding for each preset welding point.

The pneumatic control module 520 adjusts a high pressure supplied from the air compressor 300 to an air pressure suitable for maintaining the no-load balance state of the air balance cylinder 150. In other words, the pneumatic control module 520 may generate an electric signal to adjust the air pressure supplied to the air balance cylinder 150 by controlling a flow rate. Therefore, the no-load balance state of the welding gun 100 may be maintained.

The pneumatic control module 520 is characterized by allowing autonomous correction when a setting position (height) of the object 10 to be welded changes by controlling the welding gun 100 transferred to the welding point in the no-load balance state. In other words, the pneumatic control module (520) has the feature of autonomously compensating for changes in the setting position (height) of the object (10) by controlling the welding gun (100), which has been transported to the welding point, to maintain the no-load balance state.

According to an embodiment, the welding control module 510 and the pneumatic control module 520 may be configured as independent individual devices or may be integrated into one system included in the controller 500. Therefore, control functions of the welding control module 510 and the pneumatic control module 520 may be explained separately for each module, or the controller 500 integrated into one may be explained as a main subject.

According to an embodiment of the present disclosure, the welding gun 100 includes a gun body 113 on which the first welding tip 111 and the second welding tip 112 are mounted and engaged with the upper panel 11 and the lower panel 12 of the object 10 to be welded; a robot mounting bracket 120 mounting the first welding tip 111 and the second welding tip 112 on the welding robot 200; a pressing actuator 130 that presses the upper panel 11 of the object 10 to be welded at high pressure by using the first welding tip 111 during spot welding; a welding transformer (TR) 140 that supplies a welding current necessary for the spot welding; the air balance cylinder 150 that maintains the welding gun lower part in the no-load balance state by adjusting the air pressure; and a linear guide unit 160 that guides a movement of the second welding tip 112 in up and down and linear directions. For example, the linear guide unit 160 guides the vertical linear movement of the second welding tip (112).

The welding gun 100 has the equalizing function and the bidirectional pressing structure in which the second welding tip 112 in the no-load balance state rises with a reaction force when the first welding tip 111 falls and presses the upper panel 11 so that the lower panel 12 is pressed through the pressing actuator 130.

In addition, the welding gun 100 may further include cooling means (not shown) that cools the first welding tip 111 and the second welding tip 112 through cooling water during the welding.

At least one of the upper panel 11 or the lower panel 12 is made of an aluminum material.

The first welding tip 111 is connected to the pressing actuator 130 in a linear structure that enables stroke movement of the first welding tip 111.

The second welding tip 112 may be connected to the air balance cylinder 150 performing the equalizing function through the C-shaped gun body 113 and the linear guide unit 160. However, the embodiment of the present disclosure is not limited to the above, and the first welding tip 111 and the second welding tip 112 may be applied to an X-shaped gun body. For example, the welding gun 100 may be implemented in a C-shape or an X-shape according to an application form of a gun body.

During spot welding, the first welding tip 111 and the second welding tip 112 are in contact with the upper panel 11 and the lower panel 12 of the object 10 to be welded, respectively.

Hereinafter, throughout the present disclosure, the first welding tip 111 may be referred to as a welding gun upper part, and the second welding tip 112 and the gun body 113 together may be referred to as a welding gun lower part. However, the upper part and the lower part should be understood to mean positions/directions in which the upper panel 11 and the lower panel 12 and the first welding tip 111 and the second welding tip 112 are placed with respect to FIG. 2, and the directions are not limited thereto.

The welding robot 200 on which the welding gun 100 of the present disclosure is mounted moves to the designated welding point, and fixes the second welding tip 112 in contact with the lower panel 12 of the object 10. Also, through the pressing actuator 130 and the air balance cylinder 150, the welding robot 200 performs spot welding by engaging and pressing the first welding tip 111 and the second welding tip 112 with the upper panel 11 and the lower panel 12 of the object 10 to be welded in both directions while flowing high-pressure current.

A power source of the pressing actuator 130 may be implemented as a servo motor or an air cylinder.

The pressing actuator 130 may measure the depth of the welding mark of the object 10 through an encoder 131 during welding and transmit the measured depth to the monitoring unit 400. For example, the depth of the welding mark is calculated as a value by subtracting a welding completion distance value D2 from a welding start distance value D1 in a state in which the first welding tip 111 touches an upper surface of the object 10 to be welded. Also, the monitoring unit 400 may evaluate welding quality OK/NG by inspecting whether a collected depth of the welding mark satisfies a normal welding quality standard.

The welding TR 140 may convert the supplied welding current into high current suitable for spot welding while the first welding tip 111 and the second welding tip 112 are engaged with and pressed by the object 10 to be welded.

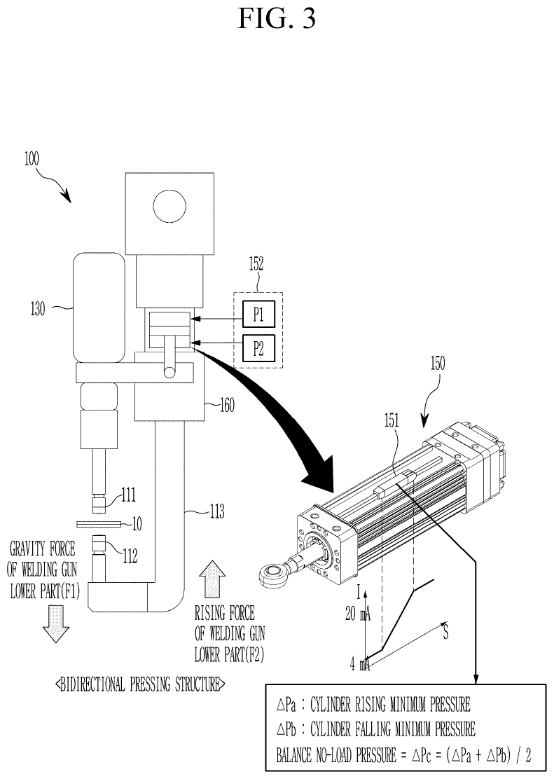

FIG. 3 illustrates a configuration of an air balance cylinder according to an embodiment of the present disclosure.

Referring to FIG. 3, the air balance cylinder 150 includes the cylinder position detecting sensor 151 that detects cylinder position change information according to a movement of the second welding tip 112 and transmits the cylinder position change information to the monitoring unit 400. Here, in the cylinder position detecting sensor 151, a current value increases when a cylinder moves backward (i.e., rises) and the current value decreases when the cylinder moves forward (i.e., falls).

In addition, the air balance cylinder 150 may further include a pressure detecting sensor 152 that measures pressures of a first port P1 and a second port P2 embedded in the cylinder and transmits the pressures to the monitoring unit 400.

The monitoring unit 400 collects monitoring information of at least one of welding quality, the cylinder position change information, and cylinder inside pressures P1 and P2 during welding of the welding gun 100 and feeds back the collected monitoring information to the controller 500. Accordingly, the controller 500 may control an equalizing function of the welding gun 100 and an aluminum material thermal expansion minimization motion during spot welding.

The controller 500 controls a bidirectional pressing operation using the equalizing function of the welding gun 100 during spot welding and the aluminum material thermal expansion minimization motion based on the received monitoring information.

The air balance cylinder 150 generates a rising force F2 corresponding to a gravity force F1 applied to a welding gun lower part to make the welding gun lower part in a no-load balance state. Such a welding gun 100 has the equalizing function and a bidirectional pressing structure in which the second welding tip 112 in the no-load balance state rises with a reaction force when the first welding tip 111 falls and presses the upper panel 11 during welding so that the lower panel 12 is pressed.

The controller 500 calculates a balance no-load pressure ΔPc required to generate the rising force F2 corresponding to the gravity force F1 applied to the welding gun lower part and controls the air balance cylinder 150 through the pneumatic control module 520. At this time, the controller 500 calculates a cylinder rising minimum pressure ΔPa and a cylinder falling minimum pressure ΔPb based on the gravity force F1. Also, the controller 500 may calculate the balance no-load pressure ΔPc as the average of sum of the cylinder rising minimum pressure ΔPa and the cylinder falling minimum pressure ΔPb. Here, the cylinder rising minimum pressure ΔPa refers to pressure at which the air balance cylinder 150 has a slightly greater force than gravity, and causes an increase in the current value of the cylinder position detecting sensor 151. The cylinder falling minimum pressure ΔPb refers to pressure at which the air balance cylinder 150 has a slightly less force than gravity, and causes a decrease in the current value of the cylinder position detecting sensor 151.

In addition, when controlling the aluminum material thermal expansion minimization motion, the controller 500 may maintain the inside of the air balance cylinder 150 at an aluminum thermal expansion minimization pressure value during welding in a state of pressing both directions of the object 10 to be welded.

Through the welding gun 100, it is possible to avoid or prevent sagging and pushing of the welding gun even when pressed with a high pressing force (e.g., 600 kgf or more) during aluminum spot welding. In addition, even if a setting position of the object 10 to be welded changes, position compensation is possible mechanically through the equalizing function and the bidirectional pressing structure of the welding gun 100, thereby avoiding or preventing deformation of a welding part.

In addition, the welding gun 100 maintains a constant pressing force on the upper panel 11 and the lower panel 12 during welding through the bidirectional pressing structure of the first welding tip 111 and the second welding tip 112.

Accordingly, it is possible to prevent pore defects due to aluminum material thermal expansion that occurs during spot welding and secure good aluminum resistance welding quality through a general welding tip and a pressing actuator. In addition, it is possible to reduce facility investment costs due to non-use of the aluminum material resistance welding special pattern tip and the multi-stage pressing control facility of the related art.

Operation mechanism of the equalizing function and the bidirectional pressure structure of the welding gun 100 according to the embodiment of the present disclosure are described in more detail.

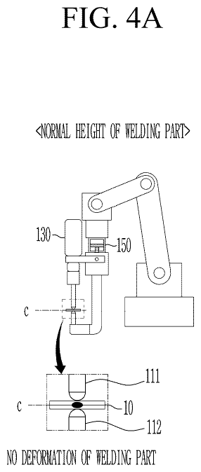

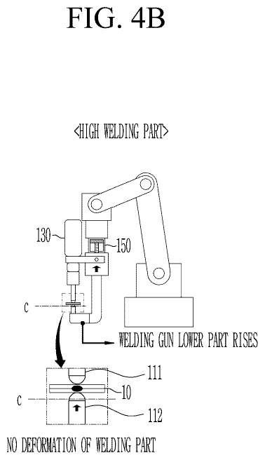

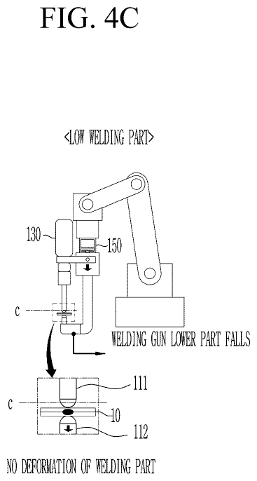

FIGS. 4A-4C illustrate examples of applying an equalizing function and a bidirectional pressing structure of a welding gun according to an embodiment of the present disclosure.

In general, referring to FIG. 4A, when the object 10 to be welded is set at a normal welding position, the welding gun 100 performs welding normally so that deformation does not occur in a welding part.

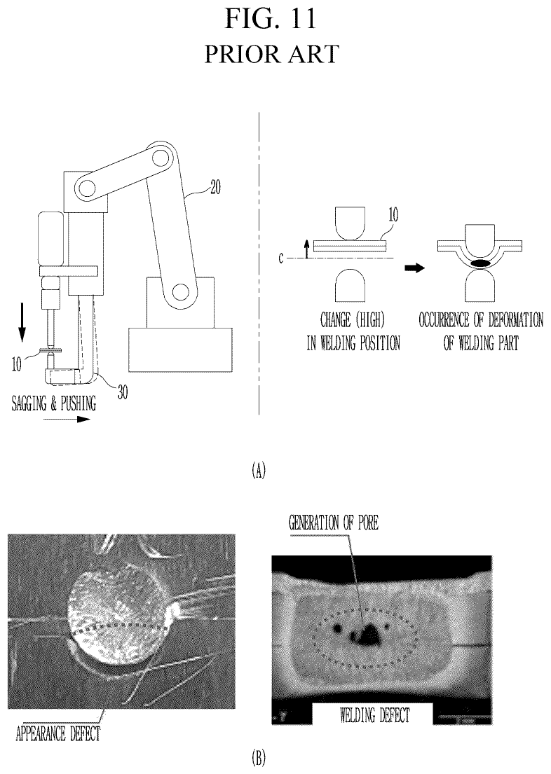

However, as described above with reference to FIG. 11, the setting position of the object 10 to be welded may change due to various causes during the spot welding of the related art. At this time, because a welding gun 20 of the related art has a fixed lower welding tip, when a setting position (height) of the object 10 to be welded changes compared to the normal value C, there is a problem that causes an appearance quality defect due to deformation of the welding part.

Accordingly, referring to FIGS. 4B and 4C, the welding gun 100 of the present disclosure has a structure in which the second welding tip 112 in a lower part of the gun body 113 is maintained in a no-load balance state through the air balance cylinder 150. Through this, the welding gun 100 may implement the equalizing function in which the second welding tip 112 in the no-load balance state autonomously corrects a welding position in accordance with a position change (e.g., high or low) of the object 10 to be welded. Therefore, the welding gun 100 prevents the appearance quality defect due to a change in the position of the welding part of the object 10 to be welded through the equalizing function of the welding gun 100.

In addition, the welding gun 100 features a bidirectional pressing structure that moves up and down, improving welding gun sagging and pushing during welding pressing, unlike the unidirectional pressing method of the prior art. Through this, the welding gun 100 may prevent a deformation defect of the object 10 due to welding gun sagging and pushing and maintain a high pressing force of 800 kgf or more. Therefore, the welding gun 100 prevents the deterioration of aluminum resistance welding quality caused by the generation of pores after welding, as seen in the related art.

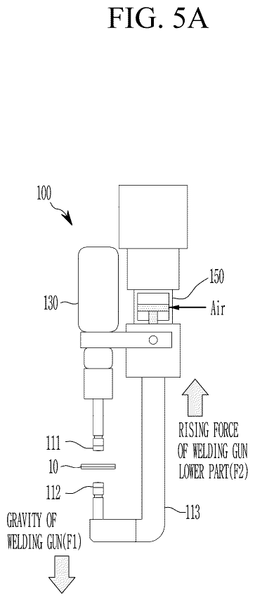

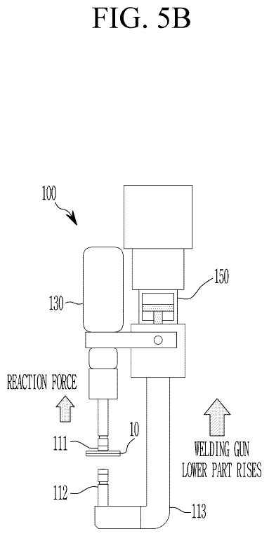

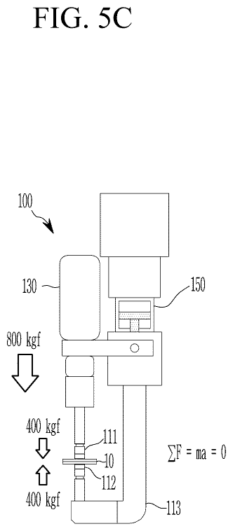

FIGS. 5A-5C illustrate a bidirectional pressing method through an equalizing function according to an embodiment of the present disclosure.

Referring to FIG. 5A, a no-load balance state of the welding gun 100 is illustrated. At this time, the welding gun 100 moves to a welding point designated by the welding robot 200 and takes a posture for spot welding.

In order to implement the equalizing function and a bidirectional pressure structure of the welding gun 100, the controller 500 firstly introduces air pressure into the air balance cylinder 150 to make the welding gun 100 in the no-load balance state.

More specifically, the gravity force F1 acts on a welding gun lower part, etc. in the air balance cylinder 150 according to the posture (position and direction) of the welding gun 100. At this time, the controller 500 inputs air pressure (hereinafter referred to as “balance no-load pressure ΔPc”) corresponding to the gravity force F1 applied to a lower part of the air balance cylinder 150 through the pneumatic control module 520. Therefore, the welding gun lower part is made in the no-load balance state by the rising force F2 that acts as the balance no-load pressure ΔPc.

Therefore, the welding gun 100 is in the no-load balance state in which a person may move the heavy welding gun lower part up and down in the current position for spot welding and in a state of capable of implementing the equalizing function.

Referring to FIG. 5B, a bidirectional pressing state of the welding gun 100 is illustrated.

The pressing actuator 130 of the welding gun 100 raises the welding gun lower part including the second welding tip 112 in the no-load balance state due to a reaction force (reaction) that occurs when the first welding tip 111 falls and contacts an upper part of the object 10 to be welded.

The pressing actuator 130 continues to advance a stroke of the first welding tip 111 until the rising second welding tip 112 contacts the lower part of the object 10 to be welded. When the first welding tip 111 and the second welding tip 112 are in contact with both the upper and lower parts of the object 10 to be welded, the reaction force is generated in a servo motor of the pressing actuator 130. The monitoring unit 400 may monitor the occurrence of a certain current value due to the reaction force of the servo motor to determine contact states of the first welding tip 111 and the second welding tip 112 of the welding gun 100.

Referring to FIG. 5C, a force equilibrium state according to bidirectional pressing completion of the welding gun 100 on the object 10 to be welded is illustrated.

As described above, the welding gun 100 completes bidirectional pressing of the welding gun 100 through a pressing force of the pressing actuator 130 and the equalizing function of the air balance cylinder 150. At this time, the total pressing force of the welding gun 100 acting on the object 10 to be welded is equally applied to the upper and lower parts of the object 10 to be welded in both directions according to the law of energy conservation and the force equilibrium state.

For example, when the total pressing force of the pressing actuator 130 is 800 kgf, an action force (400 kgf) on the upper part of the object 10 to be welded and a reaction force (400 kgf) on the lower part thereof equally act, thereby preventing welding gun sagging and pushing and preventing an appearance quality defect due to deformation of a welding object.

In addition, because the pressing force is equally applied to the upper and lower parts of the welding gun during welding, unlike the welding gun of the related art, no variation in the pressing force occurs for each welding period, which has the advantage of ensuring consistent welding quality.

In order to implement the no-load balance state and equalizing function of the welding gun 100 as above, it is desired to find and set the balance no-load pressure ΔPc of the air balance cylinder 150 according to a direction of the welding gun 100 for each welding point.

Accordingly, the controller 500 controlling the overall operations of the flawless aluminum resistance welding system 1 may perform a welding gun balance no-load pressure setting algorithm by using monitoring information of the cylinder position detecting sensor 151.

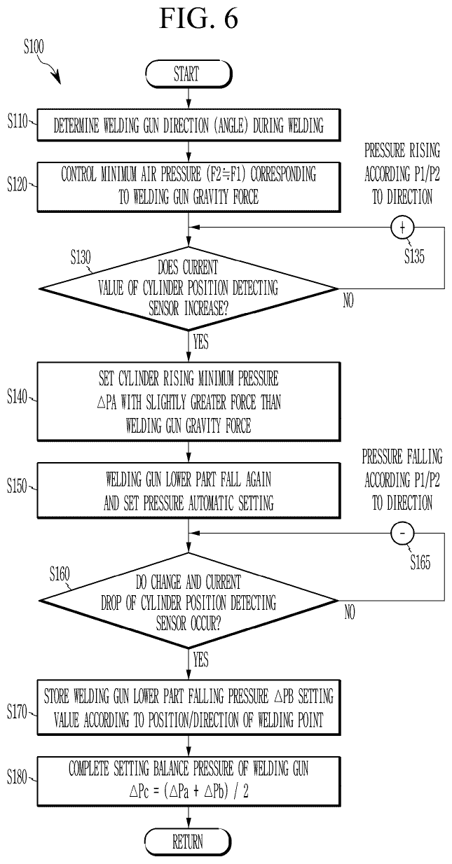

FIG. 6 is a flowchart illustrating a welding gun balance no-load pressure setting algorithm 100 according to an embodiment of the present disclosure.

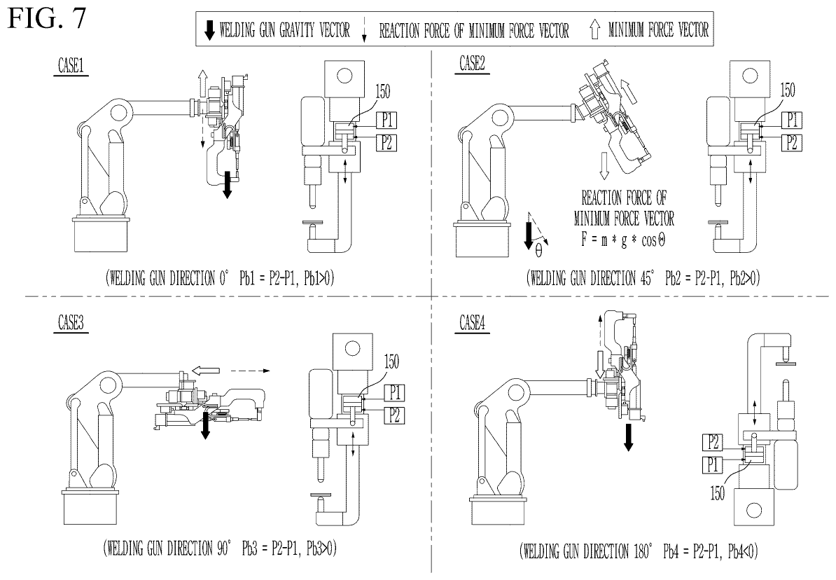

FIG. 7 illustrates an example of setting a welding gun balance no-load pressure for each direction according to an embodiment of the present disclosure.

According to an embodiment of the present disclosure, referring to FIGS. 6 and 7, the controller 500 determines a welding gun direction of the welding gun 100 (in an operation S110) for a specific welding point as a starting condition of the welding gun balance no-load pressure setting algorithm (S100). Here, the welding gun direction refers to a welding posture angle and may be obtained from kinematic posture control information of the welding robot 200 that moves the welding gun 100 to the specific welding point.

Hereinafter, the welding gun direction (0 degree) of CASE1 of FIG. 7 is continuously explained as an example.

The controller 500 controls the air balance cylinder 150 to the minimum air pressure (F2÷F1) corresponding to the welding gun gravity force (in an operation S120), and monitors the occurrence of an increase in a current value of the cylinder position detecting sensor 151 (in an operation S130). Here, the controller 500 may determine whether a cylinder piston moves backward (i.e., the welding gun lower part rises) due to the increase in the current value of the cylinder position detecting sensor 151 or the cylinder piston moves forward (i.e., the welding gun lower part falls) due to a decrease in the current value.

When the increase in the current value does not occur (S130: No), the controller 500 increases the air pressure P1 or P2 according to the welding gun direction to a slightly (level 1) great force F3 (in an operation S135). The slight (1 level) means the minimum unit capable of adjusting the air pressure up and down.

When the increase in the current value occurs (S130: Yes), the controller 500 sets the cylinder rising minimum pressure ΔPa with a slightly (1 level) greater force than the gravity force F1 in the welding gun direction (in an operation S140).

When setting of the cylinder rising minimum pressure ΔPa is completed, the controller 500 starts setting the cylinder falling minimum pressure ΔPb while controlling the welding gun lower part to fall (in an operation S150).

For example, the controller 500 reduces the air pressure P1 or P2 according to the welding gun direction to a slightly (1 level) small force in the minimum adjustment unit, and monitors the occurrence of the decrease in the current value of the cylinder position detecting sensor 151 (in an operation S160).

When the decrease in the current value does not occur (S160: No), the controller 500 continues to decrease the current value with a slightly (level 1) large force (in an operation S165).

When the decrease in the current value occurs (S160: Yes), the controller 500 sets the cylinder falling minimum pressure ΔPa with a slightly smaller force in the minimum adjustment unit than the gravity force F1 in the welding gun direction (in an operation S170).

The controller 500 derives the balance no-load pressure Pc as the average of the sum of the set cylinder piston rising minimum pressure ΔPa and cylinder piston falling minimum pressure ΔPb. Therefore, the controller 500 completes setting the balance no-load pressure Pc for a specific welding point (in an operation S180).

Thereafter, the controller 500 returns to the operation S110 and repeats the welding gun balance no-load pressure setting algorithm (S100) according to a position of each welding point set in the object 10 to be welded. Through this, the controller 500 derives and stores a setting value of the cylinder falling minimum pressure ΔPa according to the welding gun direction for each welding point.

For example, when referring to FIG. 7, a direction of the minimum force vector changes according to the direction (angle) of the welding gun 100 as shown in CASE1 to CASE4. This is because the magnitude and direction of a reaction force of the minimum force vector changes as the welding gun direction of the welding gun 100 changes, and thus, the balance no-load pressure Pc for each CASE changes.

At this time, when the welding gun direction faces downward as in CASE1, CASE2, and CASE3 (e.g., 0 degree, 45 degrees, and 90 degrees), an exhaust pressure of P2 output from the air balance cylinder 150 is greater than an inflow pressure of P1 input to the air balance cylinder 150. On the other hand, when the welding gun direction faces upward (e.g., 180 degrees), as in CASE4, the input pressure of P1 may be greater than the exhaust pressure of P2 in the air balance cylinder 150.

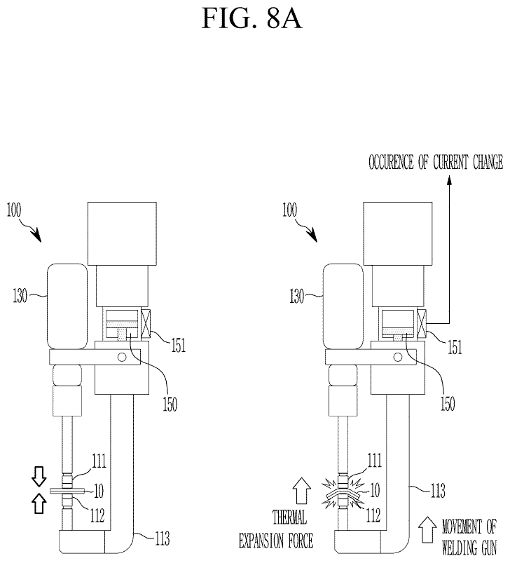

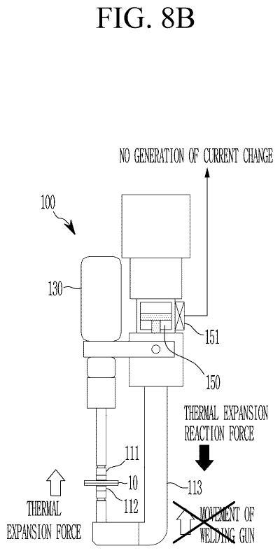

FIGS. 8A-8B are conceptual views for explaining an aluminum material thermal expansion minimization motion according to an embodiment of the present disclosure.

Referring to FIG. 8A, when aluminum resistance welding is performed in an equalizing function and a bidirectional pressing state of the present disclosure, the thermal expansion rate of an aluminum material may be high, unlike the steel resistance welding of the related art.

Because the welding gun 100 is in a no-load balance state, a force due to thermal expansion (hereinafter referred to as “thermal expansion force”) when current is applied for welding acts as up and down movement of the welding gun, which causes deformation of a welding part (i.e., a welding quality defect). At this time, the cylinder position detecting sensor 151 generates a current change according to the movement of the welding gun.

Referring to FIG. 8B, an aluminum material thermal expansion minimization motion control is performed to prevent the welding quality defect caused by the thermal expansion force during welding.

The controller 500 acts as a thermal expansion reaction force that suppresses the thermal expansion force through the air balance cylinder 150 during welding. Through this, it is possible to avoid or prevent the movement of the welding gun due to the thermal expansion force during aluminum material welding and prevent the occurrence of the welding quality defect due to deformation of the welding part. At this time, the cylinder position detecting sensor 151 does not generate a current change because there is no movement of the welding gun.

Here, the magnitude of the thermal expansion force varies depending on the characteristics of an object to be welded, including the number of welding panels, the thickness of a welding panel, and a composition ratio of an aluminum alloy material. Therefore, the controller 500 may set the thermal expansion reaction force capable of minimizing the movement of the welding gun for each designated welding point in consideration of the characteristics of the object to be welded.

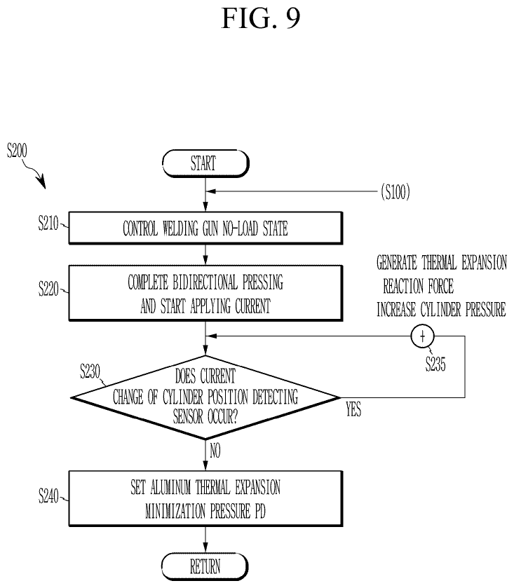

FIG. 9 illustrates an aluminum thermal expansion minimization pressure setting algorithm for implementing an aluminum material thermal expansion minimization motion according to an embodiment of the present disclosure.

Referring to FIG. 9, the aluminum thermal expansion minimization pressure setting algorithm (S200) according to an embodiment of the present disclosure may be explained as being followed after performing the above-described welding gun balance no-load pressure setting algorithm (S100).

The controller 500 inputs the balance no-load pressure ΔPc set at a specific welding point to the air balance cylinder 150 and controls the welding gun 100 in a no-load balance state (in an operation S210). Also, the controller 500 starts applying current for spot welding while pressing upper and lower parts of the object 10 to be welded through an equalizing function and a bidirectional pressing structure of the welding gun 100 (in an operation S220).

The controller 500 monitors whether the current of the cylinder position detecting sensor 151 changes when the current is applied (in an operation S230).

The controller 500 gradually increases the cylinder pressure of the air balance cylinder 150 for generating the thermal expansion reaction force corresponding to the thermal expansion force (in an operation S235) when a current change occurs due to the up and down movement of the welding gun due to the thermal expansion force (S230; Yes). At this time, the controller 500 may increase the cylinder pressure until the thermal expansion reaction force suppresses the thermal expansion force and does not cause the current change (i.e., there is no up and down movement of the welding gun).

When the current change of the cylinder position detecting sensor 151 is not detected (S230; No), the controller 500 sets the current cylinder pressure of the air balance cylinder 150 to the aluminum thermal expansion minimum pressure Pd at the specific welding point (in an operation S240).

Thereafter, the controller 500 may set the aluminum thermal expansion minimization pressure Pd corresponding to all positions set in the object 10 to be welded for each welding point by repeating the aluminum thermal expansion minimization pressure setting algorithm (S200).

According to the above description, the controller 500 may be implemented as one or more processors operating by a set program, and the set program may be programmed to perform each step of the flawless aluminum resistance welding method according to an embodiment of the present disclosure.

The flawless aluminum resistance welding method will be described in more detail with reference to the drawings below.

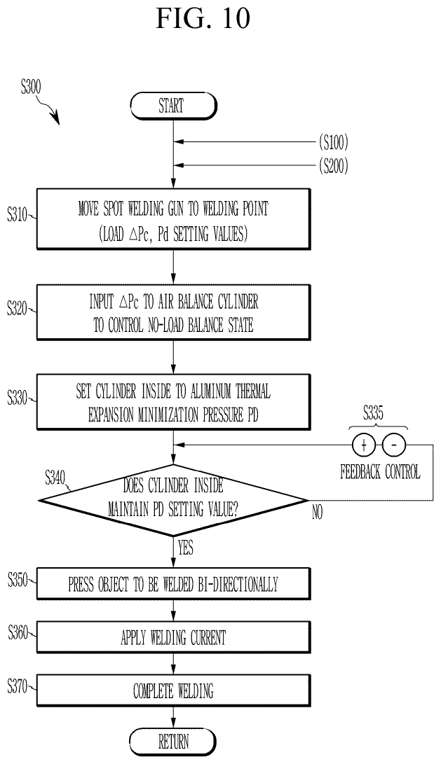

FIG. 10 is a flowchart schematically illustrating a flawless aluminum resistance welding method according to an embodiment of the present disclosure.

Referring to FIG. 10, the flawless aluminum resistance welding method according to an embodiment of the present disclosure includes setting a welding gun balance no-load pressure for each preset welding point (S100), and setting an aluminum thermal expansion minimization pressure (S200).

The controller 500 of the flawless aluminum resistance welding system 1 moves the welding gun 100 mounted on the welding robot 200 to a specific welding point (in an operation S310). At this time, the controller 500 may load the balance no-load pressure ΔPc and the aluminum thermal expansion minimization pressure Pd which are preset at the specific welding point.

The controller 500 inputs the balance no-load pressure ΔPc set at the specific welding point to the air balance cylinder 150 to make the welding gun 100 in a no-load balance state (in an operation S320).

The controller 500 controls the cylinder inside of the air balance cylinder 150 to the aluminum thermal expansion minimization pressure Pd set at the specific welding point (in an operation S330).

The controller 500 performs feedback control in which the cylinder inside maintains the aluminum thermal expansion minimization pressure Pd during welding (in operations S340, S335). At this time, the controller 500 implements a welding expansion minimization motion that occurs during aluminum resistance welding by adding/subtracting (+/−) the cylinder inside pressure according to a current change in the cylinder position detecting sensor 151.

The controller 500 presses upper and lower parts of the object 10 to be welded through an equalizing function and a bidirectional pressing structure of the welding gun 100 (in an operation S350). At this time, the welding gun 100 may press the lower part of the object 10 to be welded by raising the second welding tip 112 in the no-load balance state with a reaction force when the first welding tip 111 falls and presses the upper part of the object 10 to be welded through the pressure actuator (130).

The controller 500 applies welding current to start spot welding (S360).

The controller 500 may perform feedback control for maintaining the aluminum thermal expansion minimization pressure Pd until welding is completed.

When welding is completed (in an operation S370), the controller 500 may return to the operation S310 and repeat a flawless aluminum resistance welding process for a next welding point.

As described above, according to an embodiment of the present disclosure, through the equalizing function of the welding gun and the implementation of the welding expansion minimization motion that occurs during aluminum resistance welding, there is the effect of preventing sagging and pushing of the welding gun lower part even with a high pressing force of 800 kgf or more.

In addition, even if the setting position of the object to be welded changes, there is an effect of preventing deformation of the welding part by mechanically and autonomously correcting the welding position through the equalizing function and the bidirectional pressing structure of the welding gun.

In addition, by maintaining the constant pressing force at the upper and lower parts of the welding gun through the bidirectional pressing structure, there is an effect of preventing pore defects due to thermal expansion of the aluminum material that occurs during spot welding. Therefore, it is possible to secure good aluminum resistance welding quality through a general welding tip and a pressing actuator without the expensive special pattern tip and the pressing force multi-stage control system facility of the related art, and thus, the effect of reducing facility investment costs may be expected.

Although the embodiments of the present disclosure have been described in detail above, the scope of the present disclosure is not limited thereto, and various modifications and improvement by those having ordinary skill in the art using the basic concept of the present disclosure should be also within the scope of the present disclosure.

### DESCRIPTION OF SYMBOLS

1: aluminum resistance welding system
10: object to be welded
11: upper panel
12: lower panel
100: welding gun
111: first welding tip
112: second welding tip
113: gun body
120: robot mounting bracket
130: pressing actuator
131: encoder
140: welding transformer
150: air balance cylinder
151: cylinder position detecting sensor
152: pressure detecting sensor
160: linear guide unit
200: welding robot
300: air compressor
400: monitoring unit
500: controller
510: welding control module
520: pneumatic control module

What is claimed is:

1. An aluminum resistance welding system comprising: a welding gun,
wherein the welding gun comprises:
a gun body configured to engage a first welding tip and a second welding tip with an upper panel and a lower panel of an object to be welded;
a pressing actuator configured to press the upper panel of the object at a high pressure using the first welding tip during spot welding;
a welding transformer configured to supply a welding current necessary for the spot welding;
an air balance cylinder configured to adjust an air pressure to bring the second welding tip, which forms a welding gun lower part, into a no-load balance state; and
a linear guide unit configured to guide a movement of the second welding tip in up and down directions,
wherein the welding gun has an equalizing function and a bidirectional pressing structure in which the second welding tip in the no-load balance state rises with a reaction force when the first welding tip falls and presses the upper panel so that the lower panel is pressed through the pressing actuator.

2. The aluminum resistance welding system of claim 1, wherein:
the first welding tip is connected to the pressing actuator in a linear structure that enables a stroke movement of the first welding tip, and
the second welding tip is connected to the air balance cylinder that performs the equalizing function through the gun body and the linear guide unit.

3. The aluminum resistance welding system of claim 1, wherein the pressing actuator is configured to measure a depth of a welding mark of the object through an encoder during welding.

4. The aluminum resistance welding system of claim 1, wherein the air balance cylinder includes:
a cylinder position detecting sensor configured to detect cylinder position change information according to a movement of the second welding tip; and
a pressure detecting sensor configured to measure pressures of a first port and a second port embedded in the air balance cylinder and transmit the measured pressures to a monitoring unit.

5. The aluminum resistance welding system of claim 1, further comprising:
a welding robot on which the welding gun is mounted and configured to move the welding gun to a designated welding point position;
an air compressor configured to compress air and supply the compressed air to the welding gun;
a monitoring unit configured to detect monitoring information of at least one of cylinder position change information or cylinder inside pressures of the air balance cylinder during welding; and
a controller configured to control the equalizing function of the welding gun and an aluminum material thermal expansion minimization motion by adjusting the air pressure of the air balance cylinder based on the monitoring information.

6. The aluminum resistance welding system of claim 5, wherein the controller includes:
a welding control module configured to control a welding current and a welding time necessary for spot welding at each preset welding point; and
a pneumatic control module configured to maintain the no-load balance state by controlling the air pressure supplied to the air balance cylinder.

7. The aluminum resistance welding system of claim 5, wherein the controller is configured to:
derive and store a balance no-load pressure for controlling the equalizing function of the air balance cylinder for each welding point and an aluminum thermal expansion minimization pressure for controlling the aluminum material thermal expansion minimization motion as setting values.

8. The aluminum resistance welding system of claim 7, wherein the controller is configured to:
calculate the balance no-load pressure for generating a rising force corresponding to a gravity force applied to the welding gun lower part in consideration of a welding gun direction for each welding point.

9. The aluminum resistance welding system of claim 8, wherein the controller is configured to:
calculate a cylinder rising minimum pressure and a cylinder falling minimum pressure based on the gravity force, and
calculate the balance no-load pressure as an average of sum of the cylinder rising minimum pressure and the cylinder falling minimum pressure.

10. The aluminum resistance welding system of claim 5, wherein the controller is configured to:
maintain an inside of the air balance cylinder at an aluminum thermal expansion minimization pressure value upon applying a current for welding in a bidirectional pressing state of the welding gun when controlling the aluminum material thermal expansion minimization motion.

11. An aluminum resistance welding method comprising:
moving a welding gun that spot welds an object made of an aluminum material to a specific welding point through an equalizing function using an air balance cylinder and a bidirectional pressing structure of upper and lower welding tips of the welding gun;
making the welding gun in a no-load balance state by inputting a balance no-load pressure set at the specific welding point into the air balance cylinder;
setting a cylinder inside of the air balance cylinder to an aluminum thermal expansion minimization pressure of the specific welding point;
starting welding by pressing and applying a current to upper and lower parts of the object to be welded through the equalizing function and the bidirectional pressing structure of the welding gun; and
performing feedback control to maintain the aluminum thermal expansion minimization pressure of the cylinder inside until welding is completed.

12. The aluminum resistance welding method of claim 11, wherein moving the welding gun to the specific welding point includes:
loading the balance no-load pressure and the aluminum thermal expansion minimization pressure which are preset at the specific welding point.

13. The aluminum resistance welding method of claim 11, wherein performing the feedback control includes:
implementing a welding expansion minimization motion that occurs during aluminum resistance welding by adding or subtracting a pressure of the cylinder inside according to a current change of a cylinder position detecting sensor.

14. The aluminum resistance welding method of claim 11, further comprising:
calculating the balance no-load pressure considering a welding gun direction for each welding point through a balance no-load pressure setting algorithm; and
deriving the aluminum thermal expansion minimization pressure for each welding point through an aluminum thermal expansion minimization pressure setting algorithm.

15. The aluminum resistance welding method of claim 14, wherein the balance no-load pressure setting algorithm includes:
controlling the air balance cylinder with a minimum air pressure corresponding to a welding gun gravity force and monitoring an occurrence of an increase in a current value and a decrease in the current value of a cylinder position detecting sensor;
when the increase in the current value occurs, setting a cylinder rising minimum pressure with a force 1 level greater than the gravity force according to a welding gun direction;
when the decrease in the current value occurs, setting a cylinder falling minimum pressure with a force 1 level smaller than the gravity force according to the welding gun direction; and
deriving the balance no-load pressure as an average of sum of the cylinder rising minimum pressure and the cylinder falling minimum pressure.

16. The aluminum resistance welding method of claim 14, wherein the aluminum thermal expansion minimization pressure setting algorithm includes:
controlling the welding gun moved to the specific welding point to the no-load balance state;
starting welding by pressing and applying a current to the upper and lower parts of the object to be welded through the equalizing function and the bidirectional pressing structure of the welding gun;
when a current change of a cylinder position detection sensor occurs due to a thermal expansion force upon applying the current, gradually increasing a pressure of the air balance cylinder for generating a thermal expansion reaction force corresponding to the thermal expansion force; and
setting the pressure of the air balance cylinder when the current change is not detected to the aluminum thermal expansion minimization pressure of the specific welding point.
